(19) United States
(12) Patent Application Publication
(10) Pub. No.: US 2019/0077048 A1
(43) Pub. Date: Mar. 14, 2019

(54) METHOD OF MANUFACTURING FIBER-REINFORCED PLASTIC AND FIBER-REINFORCED PLASTIC

(71) Applicant: Toray Industries, Inc., Tokyo (JP)

(72) Inventors: Yuzo Fujita, Masaki (JP); Yuta Naito, Masaki (JP); Ichiro Taketa, Masaki (JP)

(21) Appl. No.: 16/085,327

(22) PCT Filed: Mar. 10, 2017
(86) PCT No.: PCT/JP2017/009750

§ 371 Date: Sep. 14, 2018

(30) Foreign Application Priority Data
Mar. 16, 2016 (JP) 2016-051892

(51) Int. Cl. B29B 11/16; B29C 70/08; B29C 70/10; B29C 70/30; B32B 27/30

(52) U.S. Cl. CPC B29B 11/16; B29C 70/081; C08J 5/04; B29C 70/30; B32B 27/30; B29C 70/10

(57) ABSTRACT

A method of producing a fiber reinforced plastic includes a laminating step of laminating a plurality of groups of prepregs containing an incised prepreg to obtain a prepreg laminate, when the incised prepreg is formed by providing at least a partial region in a prepreg containing unidirectionally oriented reinforcing fibers and a resin with a plurality of incisions that divide the reinforcing fibers, a forming step of disposing the prepreg laminate on a top surface of a mold containing the top surface and a side surface or disposing the prepreg laminate on a bottom surface of a mold containing the bottom surface and a side surface, and bending and forming the prepreg laminate along the side surface to obtain a preform having an approximate shape of the mold, and a solidifying step of disposing and solidifying the preform in a mold different than the mold used in the forming step.

### TECHNICAL FIELD

This disclosure relates to a fiber reinforced plastic having high mechanical properties and a production method for the fiber reinforced plastic.

### BACKGROUND

Fiber reinforced plastics made up of reinforcing fiber and resin are high in specific strength and specific modulus and excellent in mechanical properties as well as having high functional properties in weather resistance, chemical resistance and the like and, accordingly, have drawn attention for industrial uses as well. The uses of the fiber reinforced plastics have been expanded to uses as structural members of aircraft, spacecraft, motor vehicles, railways, ships, electric appliances, sports and the like, and demands for them are increasing year by year.

The fiber reinforced plastic used in structural members of aircraft and the like require high mechanical properties. Such a fiber reinforced plastic is molded by forming a prepreg laminate in which continuous reinforcing fibers are impregnated with a resin into a given shape as a preform, and solidifying the preform by autoclave and the like.

As a means to obtain the preform, a method called automated fiber placement is known, in which a wide width prepreg is cut in the fiber direction and divided to form narrow width slit tape prepregs, and then the slit tape prepregs are laminated continuously by an automated machine (For example, WO 2009/052263). By arranging the narrow width slit tape prepregs which have been deformed substantially in the two dimensions, even the forming of a complicated three dimensional shape is possible.

To use cheap and wide width prepregs and achieve a productive forming step, a forming method called hot forming has been developed, in which a prepreg laminate which has been in advance subjected to high speed lamination into a tabular shape using an automated machine is formed into a three dimensional shape by pressing against a mold while applying heat (For example, WO 96/06725).

However, the method described in WO 2009/052263 caused a problem that it took time to arrange the slit tape prepregs in a desired shape, resulting in low productivity, and also a problem of high cost of material because of the additional step of forming slit tape prepregs by cutting a wide width prepreg.

In addition, with the disclosure in WO 96/06725, when a prepreg laminate is formed into a three dimensional shape by hot forming, there exists a problem of wrinkles because the prepreg laminate cannot conform to the three dimensional shape completely, or a problem of a reinforcing fiber-free, resin-enriched portion between the reinforcing fibers and the mold because the reinforcing fibers brace. The wrinkles and the resin-enriched portion can be a defect decreasing the surface quality and mechanical properties of the fiber reinforced plastic. Therefore, the forming into a preform without a wrinkle is important.

It could therefore be helpful to provide a production method for a fiber reinforced plastic, in which a wrinkle-free preform can be formed by hot forming and the resulting fiber reinforced plastic exhibits high mechanical properties. It could also be helpful to provide a fiber reinforced plastic that has high mechanical properties in spite of its complicated shape.

### SUMMARY

We thus provide:

A method of manufacturing a fiber reinforced plastic, comprising:

a laminating step of laminating a plurality of groups of prepregs containing an incised prepreg to obtain a prepreg laminate, when the incised prepreg is formed by providing at least a partial region in a prepreg containing unidirectionally oriented reinforcing fibers and a resin with a plurality of incisions that divide the reinforcing fibers,

a forming step of disposing the prepreg laminate on the top surface of a mold containing the top surface and a side surface or disposing the prepreg laminate on the bottom surface of a mold containing the bottom surface and a side surface, and bending and forming the prepreg laminate along the side surface to obtain a preform having an approximate shape of the mold, and

a solidifying step of disposing and solidifying the preform in a mold different than the mold used in the forming step.

The fiber reinforced plastic has the following structure: A fiber reinforced plastic comprising a resin and a reinforcing fiber and having a planar surface portion and a curved surface portion,

wherein reinforcing fibers which are divided in at least a partial region are unidirectionally oriented, and resin portions P are present between fiber bundles adjacent to each other in the orientation direction of the reinforcing fibers, and

a layer A having the resin portions P in a way that a line segment interconnecting the end portions of the resin portions P is disposed obliquely to the orientation direction of the reinforcing fibers is present closer to the external perimeter than to the internal perimeter of the curved surface portion of the fiber reinforced plastic.

When a population is made up of numbers of incisions contained in ten small circular regions of 10 mm in diameter arbitrarily selected in the region of an incised prepreg, the incised prepreg has preferably a mean value for the population of 10 or greater and a coefficient of variation for the population within 20%.

It is preferable that absolute values of angles θ formed between an orientation direction of the reinforcing fibers and the incisions be substantially the same, the positive incisions whose θ is positive and the negative incisions whose θ is negative be approximately equal in number, and as an interval between a given incision and another incision that is present on an extended line of the incision and that is most proximate to the incision, intervals between the positive incisions and intervals between the negative incisions be different in length from each other.

It is preferable that the preform contain at least one out-of-plane deformation, and that the height of the out-of-plane deformation be 0.5 times or more and 3 times or less the mean thickness of the prepreg laminate.

It is preferable in the forming step that at least a partial region of the preform having an approximate shape of the mold be pressed against the mold for planarization while a shear stress is applied.

In a given resin portion P in the plane of the layer A of the fiber reinforced plastic, when two parallel lines touching the outline of the resin portion P and having the shortest distance therebetween are drawn, the distance of the parallel lines has preferably a mean value of 0.2 mm or less.

The total volume of the resin portions P within the layer A is preferably 5% or less of the volume of the layer A.

A preform without a wrinkle can be formed by hot forming, and thus a fiber reinforced plastic excellent in the surface quality and mechanical properties can be produced.

### BRIEF DESCRIPTION OF THE DRAWINGS

FIGS. 1(a)-1(c) show conceptual diagrams of the production method for the preform.

FIGS. 2(a)-2(b) show conceptual diagrams of a mold having protuberances and depressions on the side surface.

FIGS. 3(a)-3(c) illustrate examples of cross-sectional shapes of molds in the lengthwise direction.

FIGS. 4(a)-4(b) show conceptual diagrams of an incised prepreg.

FIGS. 5(a)-5(b) provide an example of an incision pattern in the incised prepreg.

FIGS. 6(a)-6(b) show conceptual diagrams of the out-of-plane deformation during the forming step.

FIG. 7 shows a conceptual diagram of the fiber reinforced plastic.

FIG. 8 shows a conceptual diagram of a resin portion P.

FIG. 9 illustrates a model which was used in Examples.

FIGS. 10(a)-10(b) show conceptual diagrams of the bending and forming method.

### EXPLANATION OF NUMERALS

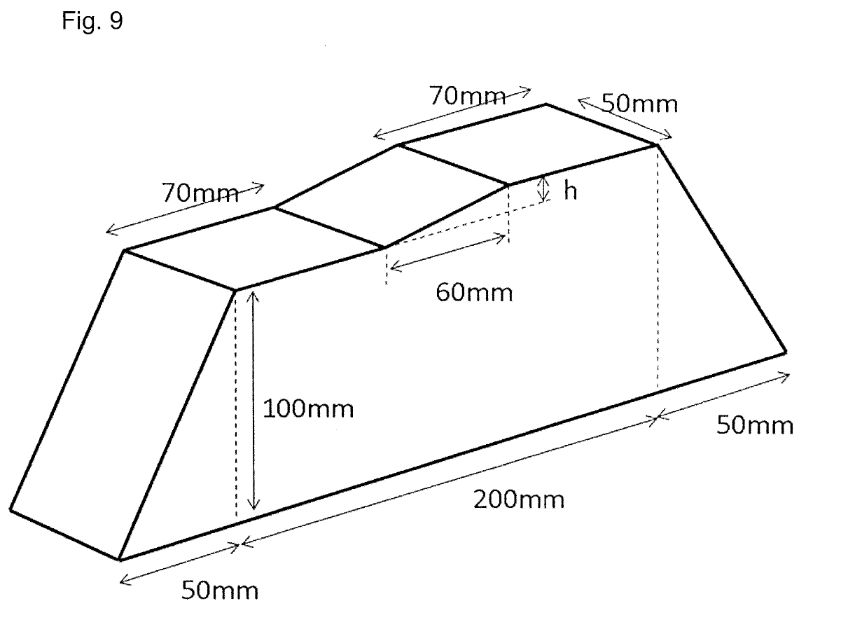

1: Prepreg laminate
2: Top surface of the mold
3: Side surface of the mold
4: Preform
5: Lengthwise direction of the mold
6: Incised prepreg
7: Incision
8: Incised region
9: Small region
10: Width of the band between the incisions most proximate to each other
11: Distance between most proximate incisions
12: Positive incision
13: Negative incision
14: Straight line on which positive incisions exist
15: Straight line on which negative incisions exist
16: End surface of the prepreg laminate during the forming
17: Out-of-plane deformation
18: Shear stress
24: Bag film
25: Mold illustrated in FIG. 9
26: Flange portion
27: Width of the resin portion P
28: Length of the resin portion P

### DETAILED DESCRIPTION

To produce a fiber reinforced plastic excellent in mechanical properties and applicable to structural members of aircraft and the like by hot forming comprising a laminating step of laminating a plurality of prepregs that contain unidirectionally oriented reinforcing fibers and a resin to obtain a prepreg laminate, a forming step of disposing the prepreg laminate on the top surface of a mold containing the top surface and a side surface or disposing the prepreg laminate on the bottom surface of a mold containing the bottom surface and a side surface, and bending and forming the prepreg laminate along the side surface to obtain a preform having an approximate shape of the mold, and a solidifying step of disposing and solidifying the preform in a mold different than the mold used in the forming step, we discovered that it is advantageous to form the prepreg laminate with groups of prepregs containing an incised prepreg formed by providing at least a partial region with a plurality of incisions that divide the reinforcing fibers.

The production method for a fiber reinforced plastic comprises a laminating step, a forming step, and a solidifying step. The laminating step is, when an incised prepreg is formed by providing at least a partial region in a prepreg containing unidirectionally oriented reinforcing fibers and a resin (hereinafter, sometimes referred to as unidirectional prepreg) with a plurality of incisions that divide the reinforcing fibers, a step of laminating a plurality of groups of prepregs containing the incised prepreg to obtain a prepreg laminate. As explained later, the group of prepregs forming the prepreg laminate is not particularly limited as long as the group of prepregs contains an incised prepreg. The group of prepregs may be in a mode only formed by incised prepregs or a mode partially containing an incised prepreg. The prepreg laminate may have partially a different lamination number depending on the target thickness of the fiber reinforced plastic which is the subject to be molded. In the incised prepreg, the region having a plurality of incisions that divide the reinforcing fibers is referred to as an incised region hereinafter. The incised prepreg in which the incisions are inserted in advance on the entire surface of the prepreg and thus which has the incised region on the entire surface is preferable because it is easy to produce and highly versatile. In the incised region, all the reinforcing fibers may be divided by incisions or fibers not divided by an incision may be contained. When a complicated form with many protuberances and depressions is formed, it is preferable that all the reinforcing fibers be divided by incisions in the incised region.

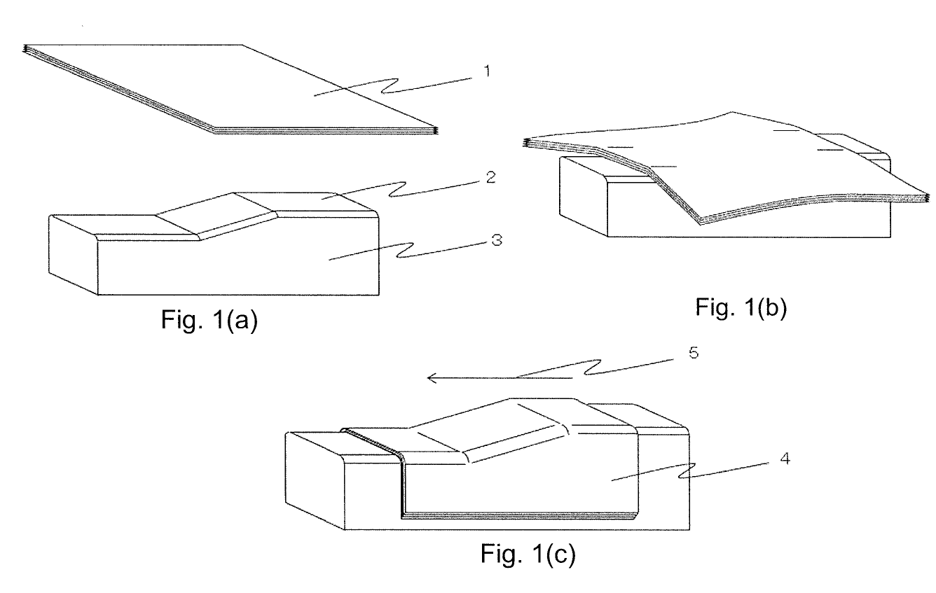

FIGS. 1(a)-1(c) show conceptual diagrams of the forming step by hot forming, in which the prepreg laminate 1 is pressed against and disposed on the top surface 2 of the mold, and then bended and formed along the side surface 3 to form a preform 4 having an approximate shape of the mold. When the mold of FIGS. 1(a)-1(c) is used upside down, the top surface 2 becomes the bottom surface. In the forming step, the substrate may be disposed under the bottom surface and bended to the side surface and thus formed. The mold may have other surfaces as long as the mold contains a top surface and a side surface. The preform having an approximate shape of the mold is a prepreg laminate having been bended and formed into a shape containing a top surface and a side surface or a bottom surface and a side surface. Before being detached from the mold, the preform having an approximate shape of the mold may be in contact with the mold, or a portion which is detached from the mold may be also present. When a portion which is detached from the mold is present before the preform having an approximate shape of the mold is detached from the mold, the preform having an approximate shape of the mold refers to the condition in which, for 80% or more of the surface of the prepreg laminate on the mold side, the distance to the surface of the mold is 3 times or less the mean thickness of the prepreg laminate.

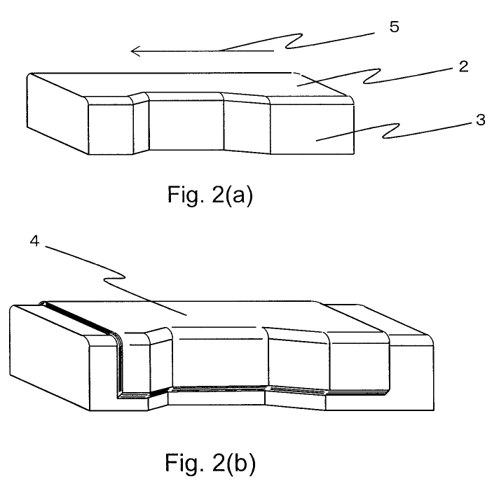

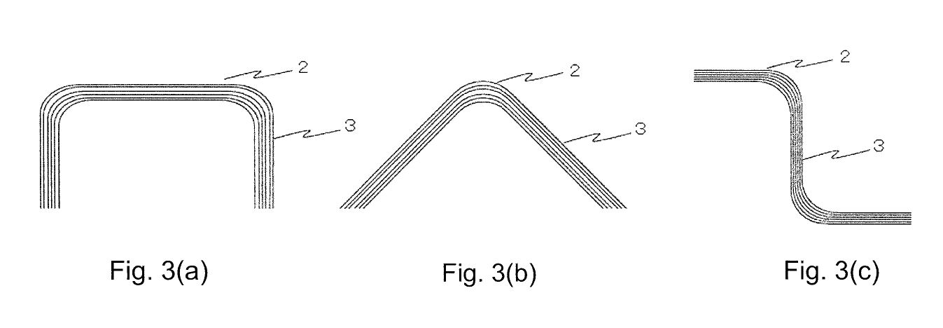

The mold used in the forming step is not particularly limited as long as it has a top surface and a side surface. In other words, the mold against which the prepreg laminate is pressed may have a protuberance and a depression on the top surface as shown in FIGS. 1(a)-1(c), or may have a protuberance and a depression on the side surface as shown in FIGS. 2(a)-2(b). The protuberances and depressions may be present on both of the top surface and the side surface, and the lengthwise direction 5 of the mold may show a curved line. The forming may be performed by using a mold in which a cross section containing the curved surface portion of the preform, for example, any of the cross sections in a C shape as shown in FIG. 3(a), in an L shape as shown in FIG. 3(b) and a Z shape as shown in FIG. 3(c), stretches in the lengthwise direction 5 of the mold. As for the mold in a C shape as shown in FIG. 3(a), the side surface may not be perpendicular to the top surface. For the forming into an L shape of FIG. 3(b), the top surface may be one surface while the side surface may be the other side. Alternatively, the top surface may be the ridge portion where two sides join while the two sides may be the side surfaces. As in the Z shape of FIG. 3(c), the mold may contain a surface different than the top surface and the side surface. Instead of having the side surfaces on both sides with respect to the top surface as in a C shape or an L shape, the mold may contain the side surface only present on one side with respect to the top surface.

In the forming step, the preform having an approximate shape of the mold is formed by bending and forming a heated prepreg laminate along the side surface. In the forming step, it is preferable that the prepreg laminate be heated by performing the bending and forming inside a chamber having a heat source or near a heater. Generally, when the prepreg laminate is bended and formed, the prepreg laminate has to be subjected to the in-plane deformation in response to the protuberances and depressions of the mold by the sliding between the prepreg layers because a perimeter difference between the inner perimeter and outer perimeter occurs. Since the unidirectional prepreg having no incision does not deform in the orientation direction of the reinforcing fibers (hereinafter, sometimes simply referred to fiber direction), the unidirectional prepreg cannot conform to the shape in some cases even when subjected to the in-plane deformation along with the sliding between the layers. On the other hand, the incised prepreg can be subjected to the in-plane deformation along with the elongation in the fiber direction and, thus, the shape conformity is improved compared to the unidirectional prepreg. Therefore, the use of groups of prepregs containing an incised prepreg as the prepreg laminate allows for the elongation even in the fiber direction and improves the shape conformity to a shape with protuberances and depressions at the time of the bending and forming. The group of prepregs forming the prepreg laminate is not particularly limited as long as the group of prepregs contains an incised prepreg. In the group of prepregs forming the prepreg laminate, all the prepregs may be incised prepregs, or incisions may be inserted only in a prepreg where the elongation in the fiber direction is necessary.

In the forming step, as a method of bending and forming, the prepreg laminate may be pressed against the mold by decompression in a sealed space, or a presser to press the prepreg laminate against the mold can be used for forming. Alternatively, the forming is performed manually.

In the solidifying step after the preform having an approximate shape of the mold is produced, to prevent a defect such as the lack of resin or the like on the surface of the fiber reinforced plastic and improve the appearance quality, the preform is preferably disposed and solidified in a mold different than the mold used in the forming step. Even when the out-of-plane deformation is contained in the preform having an approximate shape of the mold, at the time of solidification, the out-of-plane deformation is absorbed inside the plane, and a fiber reinforced plastic without any out-of-plane deformation can be obtained. The mold used in the solidifying step may be a shape that envisages the shape of the outer perimeter of the preform, or a shape of the outer perimeter which is modified in consideration of the thermal contraction or the flow of the resin. A mode is also included in which a female mold is overlaid on the mold used for the preform while the preform remains disposed therein. As a solidifying method, in a thermosetting resin, the curing is preferably performed by using an autoclave to prevent a defect such as a void, but the solidification may be also performed by controlling the heating temperature, using a vacuum in combination.

In the incised prepreg, the incisions are preferably distributed at a high density and in a uniform way. Specifically, when an incised prepreg is formed by providing at least a partial region of a prepreg with a plurality of incisions that divide the reinforcing fibers and when a population is made up of the numbers of incisions contained in ten small circular regions of 10 mm in diameter arbitrarily selected from the incised region of the incised prepreg, it is preferable that a mean value for the population be 10 or greater and a coefficient of variation therefor be within 20% (hereinafter, a state in which the mean value in a population is 10 or greater will be referred to as being highly dense, and a state in which a coefficient of variation is within 20% will be referred to as being homogeneous). Even when the same number of reinforcing fibers as in the incision distribution of a low density are divided by incision, a highly dense incision distribution can make each incision smaller, thereby minimizing the opening of each incision when the incised prepreg is elongated. As a result, the mechanical properties of the fiber reinforced plastic at the time of the solidification do not deteriorate and, furthermore, the surface quality improves. The uniform distribution of the incisions can also prevent an unbalanced and local elongation in the incised prepreg, and has the effect of ameliorating the mechanical properties and the surface quality. The reinforcing fiber length divided by incisions is preferably 10 mm or more from the viewpoint of the mechanical properties. The reinforcing fiber length divided by incisions is more preferably 15 mm or greater and further preferably 20 mm or greater. Insertion of finer incisions at a high density can provide a long incised prepreg with the reinforcing fiber length of 15 mm or more. Thus, the conformity to a three dimensional shape and a good surface quality can be maintained while a synergistic effect of preventing the decrease of mechanical properties due to the small size of each incision and improving the mechanical properties due to the long reinforcing fibers can be expected.

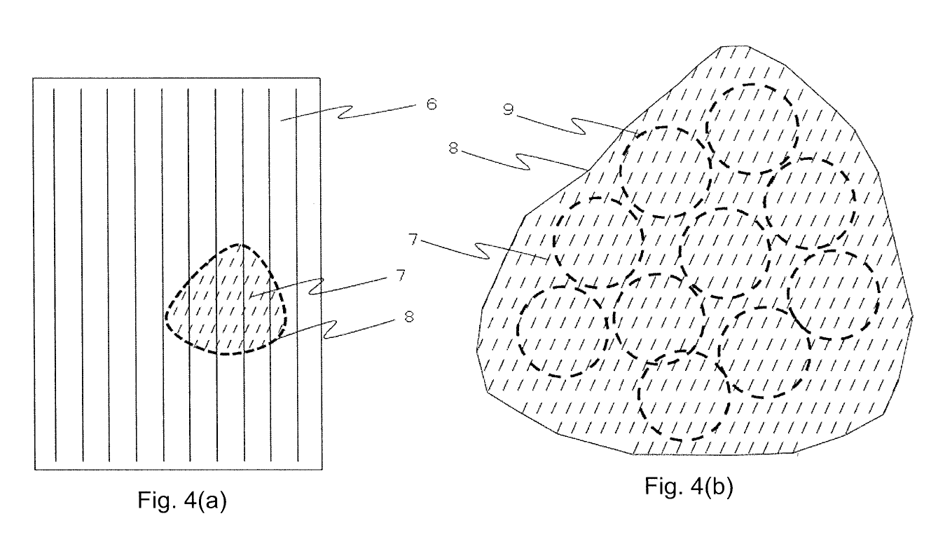

FIG. 4(a) illustrates a conceptual diagram of an incised prepreg 6 that includes an incised region 8 in which a prepreg is provided with a plurality of incisions 7. FIG. 4(b) illustrates a state in which ten circular small regions 9 of 10 mm in diameter have been extracted in an incised region 8. Although it is preferable that small regions be extracted within an incised region densely to such a degree that the small regions do not overlap with each other, it is permissible to extract small regions so that small regions overlap when the incised region is not sufficient in size to extract ten small regions without any one of them overlapping another. However, to determine the mean value for the population and the coefficient of variation therefor mentioned above with better accuracy, it is impermissible to set a small region beyond the boundary of an incised region. The boundary of the incised region is a group of line segments that is formed by linking line segments that interconnect end portions of incisions so that the group of line segments embraces therein all the incisions, and the total length of the group of line segments is minimized.

The number of incisions contained in the small region is the total number of incisions present in the small region and incisions that are partially in contact with the outline of the small region. The foregoing mean value for the population and the foregoing coefficient of variation for the population are calculated by expression (1) and expression (2), respectively, where the number of incisions in the ten small regions is nⁱ (i=1 to 10).

$$\begin{matrix}Average = \frac{1}{10} {\sum }_{i = 1}^{10} {n}_{i} & ( 1 ) \\ Variation Coefficient = \frac{1}{Average} \sqrt{\frac{1}{10} {\sum }_{i = 1}^{10} {( {n}_{i} - Average )}^{2}} & ( 2 )\end{matrix}$$

Methods of inserting incisions at a high density include a method in which the projected length Ws is made smaller than 1 mm, wherein the Ws is a length projected to a plane perpendicular to the orientation direction of the reinforcing fibers. In the forming step or the solidifying step, fibers can be flowed into the opened incisions at the same time with the elongation to make the opened incisions less obvious. A smaller Ws is preferable because this effect can be exhibited significantly.

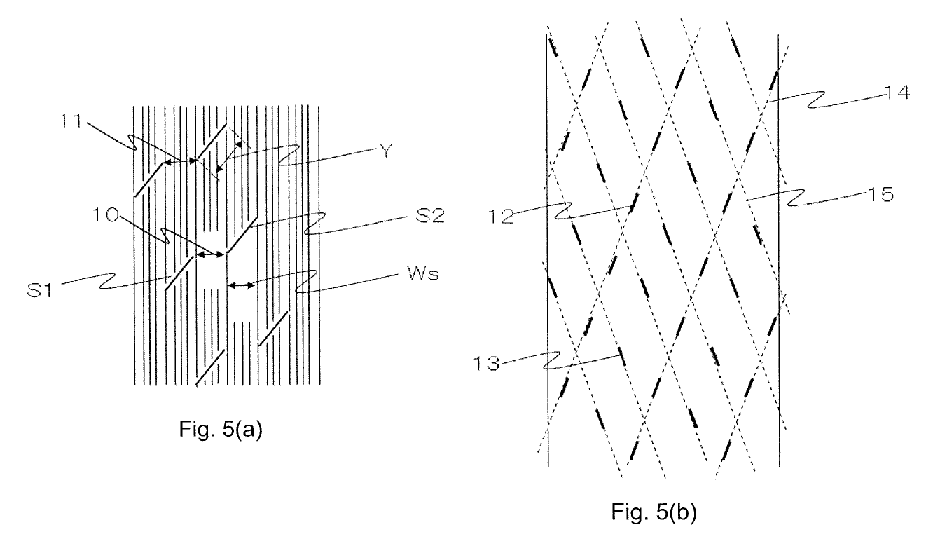

As for the incision pattern, in addition to reducing the Ws, it is also preferable that, as shown in FIG. 5(a), the given proximate incision S1 and its most proximate incision S2 do not divide the same reinforcing fibers. The reinforcing fibers divided by most proximate incisions are relatively short reinforcing fibers and therefore become a factor that reduces the mechanical properties when the incised prepreg is formed as a fiber reinforced plastic. Besides, when between the incision S1 and its most proximate incision S2 there exists reinforcing fibers that are not divided by either the incision S1 or the incision S2, the incised prepreg, when formed as a fiber reinforced plastic, is less likely to have the incision S1 and the incision S2 interconnected due to damage and therefore achieves improved mechanical properties.

The reinforcing fibers between the incision S1 and the incision S2 may be divided by an incision that is not most proximate to the incision S1 or the incision S2. Alternatively, it is permissible that reinforcing fibers between the incision S1 and the incision S2 not be divided by any incision. The width 10 of the band between the incisions most proximate to each other is, in a direction perpendicular to the reinforcing fibers, preferably at least 0.5 times a projected length Ws of the incisions projected on a plane perpendicular to the reinforcing fibers and, more preferably, at least 1 time as long as Ws.

In an incised prepreg in which incisions are highly densely distributed, if the distances between incisions are short so that incisions most proximate to each other divide the same reinforcing fiber, there is possibility of very short fibers being contained. Therefore, by providing most proximate incisions with such intervals that the most proximate incisions do not divide the same reinforcing fiber, even a highly dense incision pattern can be inhibited from having short reinforcing fibers contained and can be allowed to develop stable mechanical properties.

As a more preferred incision pattern, an incised prepreg in which the incisions have substantially the same length Y (hereinafter, Y will be referred to also as incision length) and the distance between incisions most proximate to each other is longer than 0.5 time Y can be cited. Substantially the same length refers to all the incision lengths being within ±5% from the mean value of all the incision lengths (which will apply hereinafter in the same manner). The incisions may be linear or curved and, in either case, the line segment connecting end portions of incisions represents an incision length Y.

The distance between incisions most proximate to each other means the shortest distance between the incisions most proximate to each other. When the distance between incisions most proximate to each other is short, damage formed in a fiber reinforced plastic will likely interconnect incisions; therefore, it is preferable that the distance between incisions most proximate to each other be greater than 0.5 time the incision length Y. The distance between incisions most proximate to each other is more preferably at least 0.8 time Y and, further preferably, at least 1.2 time Y. On the other hand, the distance between incisions most proximate to each other does not have a particular upper limit. However, in providing a prepreg with highly dense incisions, it is not easy to make the distance between incisions most proximate to each other at least 10 times the incision length Y.

As for an incised prepreg that has incisions distributed highly densely, the conformity to a three dimensional shape will improve and small sizes of the individual incisions will make it possible to expect improvements in mechanical properties. The improvements in mechanical properties will be greater when the incisions are remote from each other than when the incisions are closer to each other in distance. Therefore, when incisions are densely provided, an incision pattern in which the incisions are spaced in distance from each other is particularly important, more specifically, it is particularly important that the distance between incisions most proximate to each other be longer than 0.5 time the incision length Y, to improve mechanical properties. Furthermore, as shown in FIG. 5(a) of an incised prepreg in which all the reinforcing fibers are divided within an incised region to improve the formability, the distance 11 between incisions most proximate to each other being longer than 0.5 time the incision length Y and the incisions most proximate to each other not dividing the same reinforcing fiber will develop as best mechanical properties as possible without impairing the conformity to a three dimensional shape or the surface quality.

As a further preferred incision pattern, an incised prepreg in which incisions are provided obliquely to the orientation direction of reinforcing fibers can be cited. When incisions are curved, it is indicated that line segments interconnecting end portions of the incisions are oblique to the orientation direction of reinforcing fibers. Having the incisions oblique to the orientation direction of reinforcing fibers will improve the conformity of the incised prepreg to a three dimensional shape and the mechanical properties of a fiber reinforced plastic formed from the incised prepreg. Where the angle between incisions and the orientation direction of reinforcing fibers is θ, it is preferable that θ be 2 to 60°. In particular, the absolute value of θ being 25° or less conspicuously improves mechanical properties and, particularly, the tensile strength. From this viewpoint, it is preferable that the absolute value of θ be 25° or less. In the forming step, along with the elongation of the incised prepreg, θ may become smaller. A smaller θ results in a good surface quality because the opened incisions at the time of the elongation of the incised prepreg will be reduced. Moreover, the mechanical properties of the fiber reinforced plastic after the preform is solidified will ameliorate. It is preferable that the absolute value of θ be 2° or greater. In this preferred range, reinforcing fibers are not likely to escape from a blade when the blade is used to provide incisions and therefore it is possible to provide incisions while securing a positional accuracy of incisions. The incisions may be linear or curved. When incisions are curved, it is indicated that the angle formed between a line segment interconnecting end portions of the incisions and the orientation direction of the reinforcing fibers is θ.

Not only when incisions are highly densely distributed but also when the smaller the absolute value of θ, the more improvement in mechanical properties can be expected and when, in particular, all the reinforcing fibers in the incised region are divided, there is a concern that incisions are near to each other and damages that occur in incisions are likely to join together so that there is a concern that mechanical properties may deteriorate. However, it is preferable that a given incision and another incision most proximate to that incision do not divide the same reinforcing fiber and that the incisions have substantially the same length of Y and the distance between incisions most proximate to each other be controlled to be longer than 0.5 time Y because further improvements in mechanical properties can be expected compared to when incisions are perpendicular to the orientation direction of reinforcing fibers. This is preferable in particular when incisions are highly dense because improvements in mechanical properties and improvements in surface quality due to the restrained opening of the incisions can be expected.

As a preferred mode of the incised prepreg, an incised prepreg in which the absolute values of the angles θ formed between incisions and the orientation direction of reinforcing fibers are substantially the same and the positive incisions whose θ is positive and the negative incisions whose θ is negative are approximately equal in number can be cited. The absolute values of θ being substantially the same means that the angles θ in all the incisions are within the range of ±1° from the mean value of the angles θ of all the incisions. The positive incisions and negative incisions being approximately equal in number means that the number of incisions whose θ is positive and the number of incisions whose θ is negative are approximately equal. Further, the number of incisions whose θ are positive and the number of incisions whose θ is negative being approximately equal is assumed to mean that when expressed in percentage based on number, both the number of angles θ that are positive and the number of angles θ that are negative are greater than or equal to 45% and less than or equal to 55% (the same will apply hereinafter). Providing not only the positive incisions within the incised prepreg but also negative incisions therein makes it possible to macroscopically restrain shearing deformation in plane and stretch the incised prepreg due to shearing deformation occurring in the opposite direction in the vicinity of negative incisions when the incised prepreg is stretched, in-plane shearing deformation occurs in the vicinity of positive incisions.

By disposing positive incisions 12 and negative incisions 13 alternately with each other as in FIG. 5(b), a distance between proximate incisions can be easily secured while incisions are highly densely provided. An incision pattern in which the absolute values of the angles θ between the incisions and the orientation direction of the reinforcing fibers are substantially the same and the positive incisions and the negative incisions are approximately equal in number will enable lamination in substantially the same manner as common continuous fiber prepregs. Unlike in an incised prepreg containing positive incisions alone or negative incisions alone, the additional effort to control the procedure of lamination can be prevented.

The incised prepreg is further preferably an incised prepreg in which positive incisions and negative incisions are approximately equal in number, and as for the interval between a given incision and another incision that is present on an extended line of that incision and most proximate to that incision, the intervals between positive incisions and the intervals between negative incisions are different in length from each other. In FIG. 5(b), the positive incisions 12 are disposed on straight lines 14 and negative incisions 13 are disposed on straight lines 15 and the intervals between the positive incisions on the straight lines 14 are smaller than the intervals between the negative incisions on the straight lines 15. This arrangement of incisions allows securement of a distance between proximate incisions with homogeneity and high density and makes it possible to create an incision pattern in which incisions most proximate to each other do not divide the same reinforcing fiber. Furthermore, with regard to the interval between a given incision and another incision that is present on an extended line of that incision and most proximate to that incision, this arrangement of incisions makes it possible to have the length of reinforcing fibers longer than an arrangement in which the intervals between positive incisions and the intervals between negative incisions are the same in length and makes it possible to maintain mechanical properties even when incisions are distributed highly densely. An incision being present on an extended line of an incision means that the angle between a straight line extending from an incision and a straight line connecting most proximate points on the incisions concerned is within 1°.

With regard to the interval between a given incision and another incision that is present on an extended line of that incision and most proximate to that incision, when an incision pattern in which the intervals between positive incisions and the intervals between negative incisions are different in length is adopted, the reinforcing fiber length can be made longer despite high density and, furthermore, when all the reinforcing fibers within the incised region are divided, too, a given incision and another incision most proximate to that incision do not divide the same reinforcing fiber, and it becomes easier to obtain an incision pattern in which the distance between incisions most proximate to each other is longer than 0.5 time the incision length Y. This makes it possible to more effectively improve mechanical properties without impairing the surface quality and the conformity to a three dimensional shape. Considering the above, an incision pattern in which positive incisions and negative incisions are provided in approximately equal numbers, and in which, as for the interval between a given incision and another incision present on an extended line of that incision and that is most proximate to that incision, the intervals between the positive incisions and the intervals between the negative incisions are different in length, and in which a given incision and another incision most proximate to that incision do not divide the same reinforcing fiber, and in which the distance between incisions most proximate to each other is longer than 0.5 time the incision length Y, and in which substantially all the reinforcing fibers in the incised region are divided into fiber lengths of 15 mm or greater is particularly preferable from the viewpoint of the conformity to a three dimensional shape, the surface quality, and the mechanical properties.

The resin contained in the prepreg and the incised prepreg may be a thermoplastic resin or a thermosetting resin. As the thermoplastic resin, for example, polyamide (PA), polyacetal, polyacrylate, polysulphone, ABS, polyester, acryl, polybutylene terephthalate (PBT), polycarbonate (PC), polyethylene terephthalate (PET), polyethylene, polypropylene, polyphenylene sulfide (PPS), polyether ether ketone (PEEK), polyether imide (PEI), polyether ketone (PEKK), liquid crystal polymer, polyvinyl chloride, fluorine-based resins such as polytetrafluoroethylene, silicone and the like, can be cited. As for the thermosetting resin, it suffices that the thermosetting resin undergoes crosslink reaction due to heat to form at least a partial three-dimensional crosslink structure. As such thermosetting resins, unsaturated polyester resin, vinyl ester resin, epoxy resin, benzoxazine resin, phenol resin, urea resin, melamine resin, polyimide resin and the like, can be cited. Resins obtained by modifying these resins or blending two or more species thereof can also be used. Furthermore, these thermosetting resins may be resins that self-cure by heat or may also be resins that contain a curing agent, a cure accelerating agent and the like.

The reinforcing fiber contained in the prepreg and the incised prepreg may be glass fiber, Kevlar fiber, carbon fiber, graphite fiber, boron fiber and the like. Among these, carbon fiber is preferable, from the viewpoint of specific strength and specific elastic modulus.

When the volume fraction Vf of the reinforcing fibers in the prepreg laminate is 70% or less, the shifting of reinforcing fibers occurs at incised portions so that the bridging is effectively inhibited. Thus, shape conformity and an effect of inhibiting molding deficiency such as void, can be obtained. From this viewpoint, it is preferable that Vf be 70% or less. Furthermore, as Vf is lower, the bridging can be more inhibited. However, if Vf is less than 40%, high mechanical properties required for structural materials are less likely to be obtained. From this viewpoint, it is more preferable that Vf be 40% or greater. A more preferable range of Vf is 45 to 65% and, further preferably, 50 to 60%.

The prepreg and the incised prepreg may be produced by using a prepreg whose reinforcing fibers have been partially impregnated with resin (i.e., have been partly left unimpregnated). When an incised prepreg whose reinforcing fibers have been partially impregnated with resin is used, the unimpregnated portions of the reinforcing fibers within the prepreg become in-plane flow paths so that the air confined between layers of incised prepregs at the time of lamination thereof and gases such as volatile components from the incised prepregs are easily discharged to the outside of the incised prepregs (such flow paths of gases as these are called deaeration path). The rate of impregnation is preferably 10 to 90%. This preferable range allows an excellent operation property. For example, the delamination is unlikely to occur between reinforcing fibers and the resin, and the incised prepreg does not break into two parts at an unimpregnated portion at the time of lamination of incised prepregs. Moreover, the voids are unlikely to remain even when the impregnation time during the molding is not long. From this viewpoint, a more preferable upper limit of the range of the impregnation ratio is 70%, and a further preferable upper limit is 50%, and a more preferable lower limit of the range of the impregnation ratio is 20%.

In the prepreg and the incised prepreg, a resin layer may be present in a surface thereof. As a resin layer is present in a surface of the incised prepreg, an inter-layer resin layer is molded between incised prepregs when the incised prepregs are laminated. Therefore, when an out-of-plane impact load acts, crack is induced in a soft inter-layer resin layer and the presence of the thermoplastic resin achieves high toughness, inhibiting the delamination so that the residual compressive strength subsequent to the out-of-plane impact can be increased. Thus, this incised prepreg is suitable as materials of main structures with high safety requirements for aircraft and the like.

Preferably, as an example, the preform contains at least one out-of-plane deformation, and the height of the out-of-plane deformation is 0.5 times or more and 3 times or less the mean thickness of the prepreg laminate.

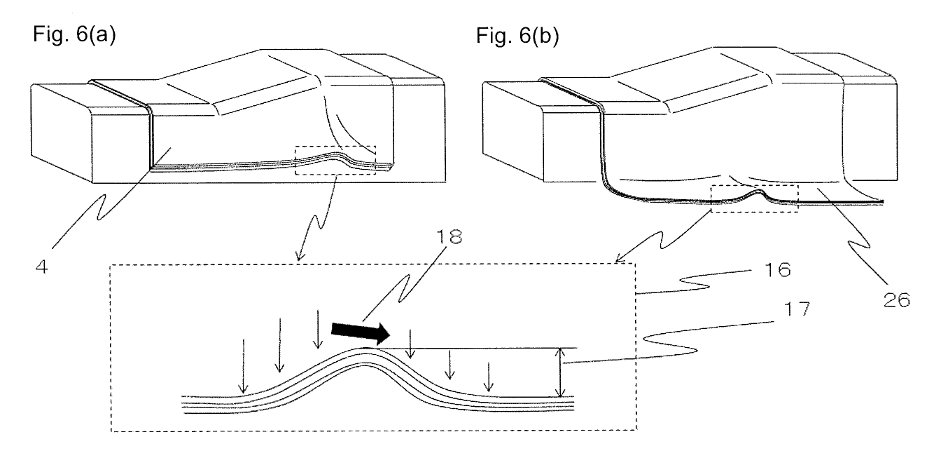

For the mean thickness of the prepreg laminate, the prepreg laminate in the tabular shape before the forming is measured for the thickness using a ratchet micrometer with a flat distal end at a measurement pressure of 5N, and the mean value of the thickness measured at three sites in the end portion of the prepreg laminate is determined. The out-of-plane deformation of the preform indicates, when the end surface 16 of the preform is viewed after the bending and forming as shown in FIGS. 6(a)-6(b), the maximal value of the height difference 17 at a site with a difference in level like between a protruding portion and a flat portion of the end surface. When a depressed portion is present in addition to the protruding portion and the flat portion, the out-of-plane deformation of the preform refers to the difference in height either between the depressed portion and the planar surface portion or between the depressed portion and the protruding portion (also referred to as wrinkle). In other words, the out-of-plane deformation of the prepreg laminate during the forming step means the maximal value of the height difference in the end portion of the prepreg laminate during the forming.

In a unidirectional prepreg without an incision, the out-of-plane deformation cannot be absorbed inside the plane. As a result, when the out-of-plane deformation is observed in the preform, a fiber reinforced plastic having a poor appearance quality is obtained upon the solidification. Even when it is difficult to keep the out-of-plane deformation 0.5 times or less the mean thickness of the prepreg laminate, the out-of-plane deformation can be absorbed inside the plane during the solidifying step. Therefore, even with the presence of the out-of-plane deformation in the preform, a fiber reinforced plastic with a good appearance quality can be obtained. This is an effective method at a site to which a high pressure can be applied upon the solidification such as, in particular, the flange 26 shown in FIG. 6(b). However, when the out-of-plane deformation is too large, it cannot be absorbed inside the plane. Therefore, the height of the out-of-plane deformation is preferably 3 times or less the mean thickness of the prepreg. By tolerating the residual out-of-plane deformation in the preform, the effort to remove the out-of-plane deformation in the preform can be reduced, resulting in a better productivity of the fiber reinforced plastic.

In the forming step, it is preferable that the bending and forming be performed such that the out-of-plane deformation of the prepreg laminate is always 3 times or less the mean thickness of the prepreg laminate. The out-of-plane deformation of the prepreg laminate is further preferably 1 times or less. As a specific method of controlling the out-of-plane deformation of the prepreg laminate, a device provided with several pressers which compress the prepreg laminate against the mold in the out-of-plane direction may be used to perform the forming while controlling the pressers by the detection of the out-of-plane deformation with a sensor or the like. The bending and forming may also be performed by checking the change in thickness visually and pressing manually the site showing a large out-of-plane deformation. The site or the timing of pressing the prepreg laminate may be determined by running a preparatory bending and forming test or a simulation so that the out-of-plane deformation is maintained 3 times or less the mean thickness of the prepreg laminate during the forming step.

Further preferably, it is preferable in the forming step that at least a partial region of the preform having an approximate shape of the mold be pressed against the mold for planarization while a shear stress is applied. As described above, a fiber reinforced plastic with a good appearance quality can be obtained even when the out-of-plane deformation is present in the preform. Nonetheless, when the out-of-plane deformation is present on the side surface where it is difficult to apply pressure upon the installation of the preform in a female mold during the solidifying step, the out-of-plane deformation in the preform may be planarized in advance. In a prepreg laminate only formed by groups of prepregs having no incision, the prepreg laminate does not elongate in the fiber direction. Thus, the out-of-plane deformation on the preform cannot be removed, and the protuberances and depressions remain. On the other hand, with the incised prepreg, by pressing the preform against the mold and applying a shear stress in the out-of-plane direction, the out-of-plane deformation can be absorbed inside the plane, resulting in the planarization.

FIGS. 6(a)-6(b) illustrate conceptual diagrams in which the preform 4 having the out-of-plane deformation is pressed against the mold while the shear stress 18 is applied. The shearing deformation is preferably carried out in the direction that stretches the out-of-plane deformation. Specific examples of the method of applying the shear stress include pressing the mold with a roller or the like, rubbing by hand to planarize the out-of-plane deformation manually and the like. The step of carrying out this planarization is preferably carried out in a temperature range in which the prepreg laminate softens as the in-plane prepreg laminate easily deforms. In the forming step, it is preferable that the out-of-plane deformation of the prepreg laminate be 3 times or less the mean thickness of the prepreg laminate because the out-of-plane deformation can be more easily planarized by shear stress. When the preform having an approximate shape of the mold is pressed against the mold with the shear stress applied and thus planarized, it is possible to press against the mold for the planarization while applying the shear stress to the entire preform. However, the planarization by pressing against the mold while applying the shear stress only to a certain site having a large protuberance and depression is sufficient.

As described above, the out-of-plane deformation in the preform is tolerated and solidified and the solidification is performed after the planarization. The choice of the method is determined as follows: the out-of-plane deformation can be tolerated when a large pressure, for example, a pressure of 3 MPa or more, can be applied, in the solidifying step, to the site where the out-of-plane deformation occurs while the out-of-plane deformation is preferably made flat when a large pressure cannot be applied.

We also provide a fiber reinforced plastic preferably applicable to stringers of aircraft and the like, having excellent mechanical properties, and containing a curved surface. That is, provided is a fiber reinforced plastic comprising a resin and a reinforcing fiber and having a planar surface portion and a curved surface portion, wherein reinforcing fibers which are divided in at least a partial region are unidirectionally oriented, and resin portions P are present between fiber bundles adjacent to each other in the orientation direction of the reinforcing fibers, and a layer A having the resin portions P in a way that a line segment interconnecting the end portions of the resin portions P is disposed obliquely to the orientation direction of the reinforcing fibers is present closer to the external perimeter than to the internal perimeter of the curved surface portion of the fiber reinforced plastic. The production method of such a fiber reinforced plastic is not particularly limited. For example, such a fiber reinforced plastic can be obtained by the production method comprising the laminating step, the forming step, and the solidifying step as explained above.

The curved surface portion refers to a site where the radius of curvature of the external diameter of the fiber reinforced plastic is 1 to 100 mm.

In the fiber reinforced plastic, a plurality of the layers A can be present. In this case, the orientation direction of the reinforcing fibers in each layer A may be the same or different. In the portion excluding the layer(s) A, the orientation condition of the reinforcing fibers is not particularly limited, but the unidirectional orientation is preferable because the reinforcing fiber volume fraction can be increased and the mechanical properties in the orientation direction of the reinforcing fibers will be significantly ameliorated.

When a cross section that cuts through the fiber reinforced plastic in the thickness direction is observed, the cross sections of the reinforcing fibers can take various shapes from a line shape to a circular shape when the reinforcing fibers are oriented randomly. On the other hand, when the reinforcing fibers are oriented unidirectionally, the reinforcing fibers have the same cross section. For example, in a cross section at right angle to the fiber direction, the cross section of the fibers is a circle. In a cross section oblique to the fiber direction, the cross section of the fibers is an ellipse. In the cross section that cuts through the fiber reinforced plastic in the thickness direction, a layer can be observed visually in the thickness direction. In this layer, when the coefficient of variation of longest diameters of the cross sections of the 100 reinforcing fibers selected randomly is 20% or less, the reinforcing fibers present in the layer are considered to be oriented unidirectionally. In a layer A of the fiber reinforced plastic, resin portions P are present between fiber bundles adjacent to each other in the orientation direction of the reinforcing fibers (hereinafter, referred to as fiber direction). In the fiber reinforced plastic made of short fibers, when the resin portions P are present between the fiber bundles adjacent to each other in the fiber direction, the resin portions support a small load, and thus are likely to be a point of origin of a damage. Therefore, for the resin portions to transfer the load between the adjacent fiber bundles by a shear stress, a line segment interconnecting the end portions of the resin portions P is preferably disposed obliquely to the orientation direction of the reinforcing fibers. Furthermore, the length of all the reinforcing fibers is preferably 10 mm to 50 mm.

To improve the stiffness in the curved surface portion of the fiber reinforced plastic, the fiber reinforced plastic contains a layer A comprising the resin portions P at a site closer to the side of the external perimeter than to the side of the internal perimeter of the curved surface portion. Thus, the curved surface portion is also filled with the reinforcing fibers thoroughly.

When a load is applied to the fiber reinforced plastic, a high stress is likely to occur in the curved surface portion, which results easily in a damage. Therefore, it is preferable that the thickness of the layer A in the curved surface portion be thinner than the thickness of the layer A in the planar surface portion because the resin portions P also become thinner and the damage can be prevented.

The fiber reinforced plastic may be molded from a prepreg laminate containing an incised prepreg which is/are formed by providing a prepreg in which the reinforcing fibers have been arranged in advance unidirectionally with incisions. A prepreg in which short fibers are arranged unidirectionally and impregnated with a resin may also be used.

In a further preferred mode of the fiber reinforced plastic, in a given resin portion P in the plane of the layer A, when two parallel lines touching the outline of the resin portion P and having the shortest distance therebetween are drawn, the distance of the parallel lines has a mean value of 0.2 mm or less.

When the distance between the two parallel lines touching the outline of the resin portion P and having the shortest distance therebetween is considered as the width of the resin portion P, a smaller width of the resin portion P is preferable because the transfer of the load between the fibers adjacent to each other with the resin portion P sandwiched therebetween is carried out efficiently. The width of the resin portions P has preferably a mean value of 0.15 mm or less.

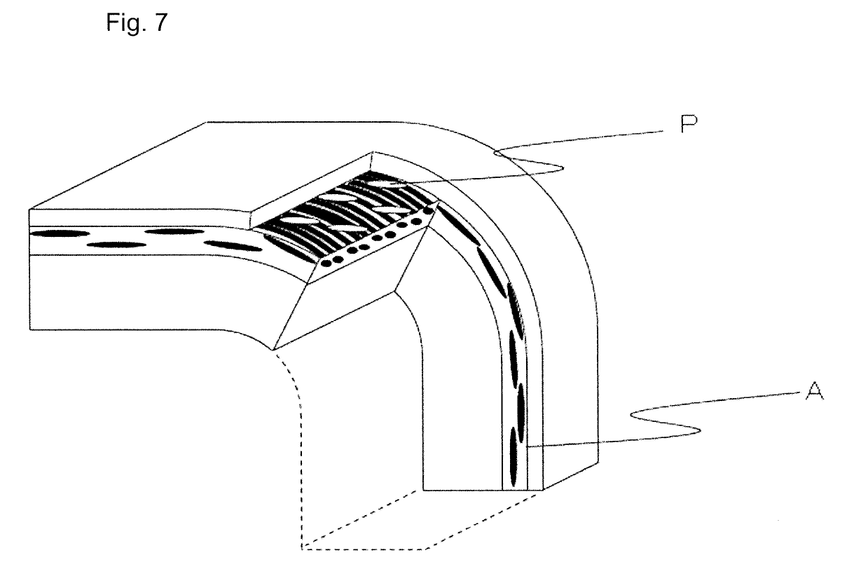

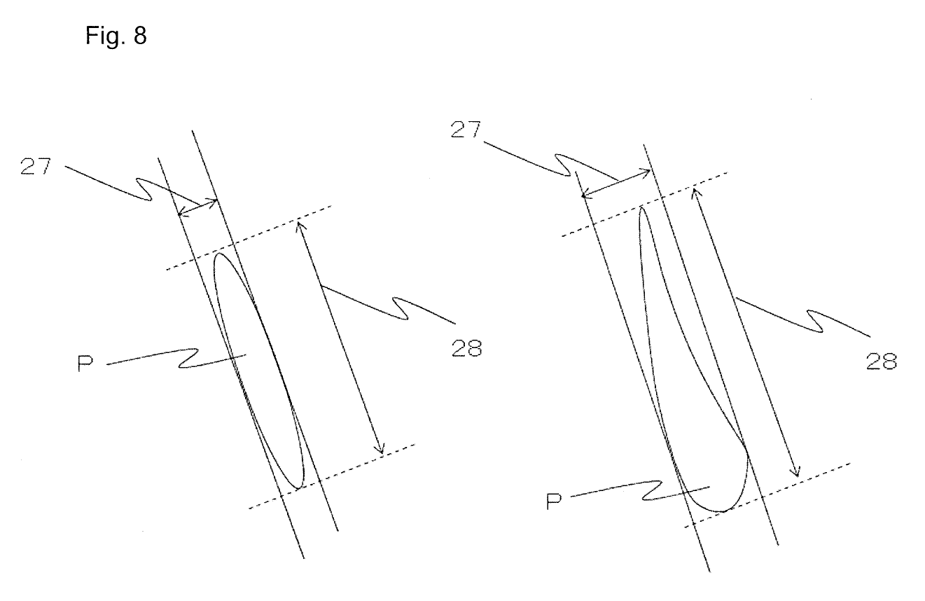

The mean value of the width of the resin portions P can be obtained by calculating the mean value of the width of 10 resin portions P selected from an image taken by an imaging device such as a digital microscope or the like of the surface of the layer A which has been carved out by a grinding machine or the like as shown in FIG. 7. The width of a resin portion P is, as shown in FIG. 8, the distance 27 between two parallel lines touching the outline of the resin portion P. The means to draw the two parallel lines may be done manually after the image is printed out, or a measuring means equipped with the digital microscope may be used.

In a further preferred mode of the fiber reinforced plastic, the total volume of the resin portions P within the layer A is 5% or less of the volume of the layer A. The total volume of resin portions P is preferably 5% or less, and more preferably 3% or less of the total volume of the fiber reinforced plastic. In this preferred range, the surface quality of the fiber reinforced plastic does not worsen and does not cause a defect in a structure, either. The ratio of the volume of the resin portions P in the curved surface portion is preferably 0.1% or more of the volume of the layer Ain the curved surface portion. This preferable range results in a lower possibility that a void or the like occurs because the resin fails to be filled between the reinforcing fibers adjacent to each other in the fiber direction, thereby preventing the decrease in mechanical properties.

The volume of a resin portion P in the layer A is, on the supposition that the resin portion P has the same shape in the thickness direction, calculated from the area of the resin portion P measured from the surface of the layer A. The area of one resin portion P is defined as a half of the product of the width of the resin portion P and the length of the resin portion P. The length of the resin portion P is, as shown in FIG. 8, the longest distance 28 of the two parallel lines touching the outline of the resin portion P. The layer A is observed for the region of the surface of 10 mm×10 mm, and the total area (mm²) of all the resin portions P present in the region is the volume ratio of the resin portions P (%) in the layer A.

### EXAMPLES

Hereinafter, our methods and plastics will be further concretely described with reference to examples. However, this disclosure is not limited to the examples.

### Production of Prepreg Laminate

A prepreg sheet of TORAYCA (registered trademark), P3052S-15 (reinforcing fiber: T700S, resin: 2500, and volume fraction of reinforcing fibers: 56%, and a mold release paper is laminated on a side surface) was pressed against a roller with rotary blades with the blades disposed in given sites to provide incisions penetrating the prepreg. The incised region was the entire prepreg, and all the reinforcing fibers were divided by the incisions. In any Example, when the resin in the incised prepreg of 200 mm×200 mm was burned off at 400° C., it was confirmed that the reinforcing fibers of 200 mm did not remain and that all the reinforcing fibers were divided.

The groups of prepregs forming the prepreg laminate were all incised prepregs. In the laminating step, with a side and the other side perpendicular to the side of a square of 150 mm×150 mm being 0° and 90°, respectively, lamination was performed so that the orientation direction of the reinforcing fibers of the incised prepreg would be [+45°/0°/−45°/90° ]₂ₛ. After the lamination, the layers of the groups of prepregs were tightly attached by vacuuming for 30 minutes to obtain a prepreg laminate of 150 mm×150 mm.

### Evaluation of Distribution of Incisions

Several photos of the surface of the incised prepreg were taken by a digital microscope at a magnification of 10×, and the photos were joined on a screen to display the incised prepreg surface of 50 mm×50 mm on the screen. Using a measurement software, 10 circles of 10 mm in diameter were drawn so that the centers of three adjacent circles would form an equilateral triangle like the arrangement of bowling pins. The distance between the centers of the two adjacent circles was 12 mm. The number of incisions contained in each circle or touching each circle was counted as a population, and the mean value and the coefficient of variation of the population calculated.

### Evaluation of Formability

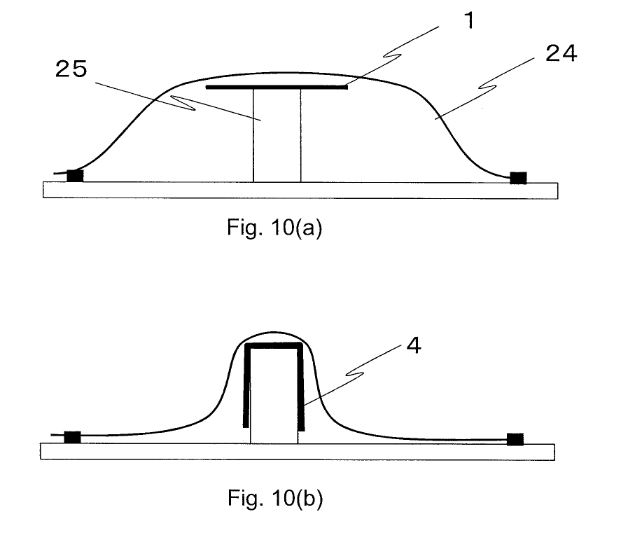

On the top surface of the mold of FIG. 9 containing a top surface and a side surface and having a shape of the C-shaped cross section which continues in the lengthwise direction, a prepreg laminate was disposed so that 0° of the prepreg laminate would be in the lengthwise direction. The prepreg laminate was bended and formed along the side surface to obtain a preform having an approximate shape of the mold. For the forming method, as shown in FIGS. 10(a)-10(b), the mold was placed on a plate, and the prepreg laminate was placed thereon. After the sealing with a bag film, the bag film was drawn to the mold by vacuuming, and at the same time, the prepreg laminate was bended and formed. When the out-of-plane deformation occurred, a shear stress was applied manually to press against the mold for the planarization. This forming step was carried out in an oven under the temperature control at 60° C. For the mold, a mold with the h in FIG. 9 being 2 mm and a mold with the h in FIG. 9 being 6 mm were prepared. The resulting preform was evaluated for the conformity to a three dimensional shape in the following three 3 grades.

A: The first bending and forming allowed the preform to conform to the shape.
B: After the first bending and forming, the out-of-plane deformation occurred. However, the pressing against the mold while applying a shear stress could planarize the out-of-plane deformation.
C: After the first bending and forming, the out-of-plane deformation occurred. Although the preform was pressed against the mold while a shear stress was applied, the out-of-plane deformation could not be planarized and remained.

### Surface Quality of Fiber Reinforced Plastic

The above preform was removed from the mold and installed in a female mold different than the mold used for the bending and forming. The preform and the mold were covered with a bag film and hardened under a vacuum in an autoclave at 130° C. for 1.5 hours. The surface of the produced fiber reinforced plastics was checked visually and divided into the following three grades. The undulation of the reinforcing fibers indicates a disturbed orientation of reinforcing fibers which occurs on the surface of the fiber reinforced plastic and worsens the surface quality.

A: The opening of incisions was hardly recognizable, and no undulation of the reinforcing fibers occurred.
B: The opening of incisions was recognizable, but no undulation of the reinforcing fibers occurred.
C: The undulation of the reinforcing fibers occurred.

### Evaluation of Orientation Condition of Reinforcing Fibers

In the resulting fiber reinforced plastic, the site having a slope on the top surface of the mold in FIG. 9 was cut in center to a plane perpendicular to the lengthwise direction to obtain a rectangular cross section. The site corresponding to the top surface was cut out to a size of 10 mm×10 mm. In the 8 layers located on the side closer to the external perimeter in the curved surface portion, the cross-sectional shape of the reinforcing fibers was observed. In each layer, the longest diameters of the cross sections of the 100 reinforcing fibers selected randomly were measured. When the coefficient of variation of the longest diameters was 20% or less, the reinforcing fibers present in the layer were considered to be oriented unidirectionally.

### Measurement of Width of Resin Portions P

For the layers in which reinforcing fibers were considered as unidirectional in the evaluation of the orientation condition of reinforcing fibers, the surface of each layer was carved out in order from the external layer, using a grinding machine. In the layer in which resin portions P were observed, the widths of 10 resin portions P were measured to calculate the mean value.

### Measurement of Volume Ratio of Resin Portions P

Along with the measurement of the width of the resin portions P, the lengths of the resin portions P were also measured. The sum of the products of the width×length×½ for all the resin portions P contained in the image of the surface of the 10 mm×10 mm square was calculated and then divided by 100 mm² to calculate the ratio of the volume of the resin portions P contained in the layer A.

### Mechanical Properties

Because it was difficult to compare the strength of a fiber reinforced plastic having a curved surface portion, a test piece in a tabular shape was prepared to perform a tensile test. The incised prepregs cut out to the size of 350 mm×350 mm were laminated at a lamination structure of [+45°/0°/−45°/90° ]_{2S}, and hardened in an autoclave at 130° C. for 1.5 hours.

After molding the plate, test pieces of 25 mm×250 mm were cut out so that the 0-degree direction was in the lengthwise direction, and were subjected to a tensile test by a method stipulated in ASTM D3039 (2008). The numbers of test pieces measured were five for each level. Mean values of the tensile elastic modulus and the tensile strength were calculated as representative values.

### Example 1

A prepreg laminate was formed from incised prepregs in which the incision pattern was as illustrated in FIG. 5(a), the divided reinforcing fiber length was 20 mm, the projected length Ws of the incisions projected to a plane perpendicular to the orientation direction of reinforcing fibers=5 mm, and the angle θ formed between the incisions and the orientation direction of the reinforcing fibers was 45°.

In the evaluation of the distribution of the incisions, the mean value for the population was 1.6 and the coefficient of variation therefor was 32%.

In the evaluation of the formability, when h=2 mm, the forming was performed without any problem. However, when h=6 mm, the planarization could not be achieved and the out-of-plane deformation remained. As for the surface quality of the fiber reinforced plastic after being hardened, the opening of incisions was seen in the surface both when h=2 mm and h=6 mm. The mechanical properties were very poor compared to being without any incision.

The width of the resin portions P of the fiber reinforced plastic was 0.24 mm, and the volume of the resin portions P was 5.7%. The tensile strength was 490 MPa.

### Example 2

A prepreg laminate was formed from incised prepregs in which the incision pattern was as illustrated in FIG. 5(a), the divided reinforcing fiber length was 20 mm, the projected length Ws of the incisions projected to a plane perpendicular to the orientation direction of reinforcing fibers=0.2 mm, and the angle θ formed between the incisions and the orientation direction of reinforcing fibers was 14°. In the evaluation of the distribution of the incisions, the mean value for the population was 17.5 and the coefficient of variation therefor was 8%.

In the evaluation of the formability, when h=2 mm, the forming was performed without any problem. However, when h=6 mm, the planarization could not be achieved and the out-of-plane deformation remained. As for the surface quality of the fiber reinforced plastic, no opening of incisions was seen in the surface when h=2 mm. When h=6 mm, the opening of the incisions was seen but less visible than in Example 1.

While the width and the volume of the resin portions P of the fiber reinforced plastic were both smaller than in Example 1, the tensile strength was higher than in Example 1.

### Example 3

A prepreg laminate was formed from the incised prepregs having the incision pattern illustrated in FIG. 5(b). For the length of all the incisions, the length of divided reinforcing fibers was 20 mm, the projected length Ws of the incisions projected to a plane perpendicular to the orientation direction of reinforcing fibers was 0.2 mm, and the angle θ formed between the incisions and the orientation direction of reinforcing fibers was 20°. Furthermore, the positive incisions whose θ was positive and the negative incisions whose θ was negative were approximately equal in number, and the intervals between incisions present on an extended line of incisions were different for the positive incisions (2.8 mm) and the negative incisions (17 mm). In the evaluation of the distribution of the incisions, the mean value for the population was 15.1 and the coefficient of variation therefor was 6%. The incisions were distributed at a high density and homogeneously.

In the evaluation of the formability, when h=2 mm, the forming was performed without any problem. When h=6 mm, the out-of-plane deformation was observed, but could be planarized. After the hardening, a good quality was exhibited both when h=2 mm and 6 mm.

While the width and the volume of the resin portions P of the fiber reinforced plastic were both further smaller than in Example 2, the tensile strength further improved compared to Example 2.

### Example 4

The same incised prepreg laminate as in Example 3 was used to form a flange portion in addition to the bending and forming in the forming step to prepare a preform with a flange as shown in FIG. 6(b). The out-of-plane deformation remained at the end of the preform. The height was 1.8 times the thickness of the prepreg laminate. It was considered that the out-of-plane deformation could be reduced by applying a shear stress from outside the plane, but it would require efforts. Therefore, the preform was installed in a female mold that could apply pressure to the flange as well while the out-of-plane deformation was still present. Thus, a fiber reinforced plastic was produced like in Examples 1 to 3. As a result, the out-of-plane deformation present on the flange disappeared and a fiber reinforced plastic with a flat flange could be produced.

### Comparative Example 1

A prepreg laminate was formed only from prepregs without any incision. Both when h=2 mm and 6 mm, the out-of-plane deformation occurred and the planarization could not be achieved. For the surface quality after the hardening, the undulation of the fibers was observed both when h=2 mm and 6 mm.

TABLE 1

| | Conformity to a | | Surface | | | | |
|---|---|---|---|---|---|---|---|
| | three dimensional | | quality of fiber | | Average width of | | Tensile |
| | shape | | reinforced plastic | | resin portion P | Volume ratio of | strength |
| | h = 2 mm | h = 6 mm | h = 2 mm | h = 6 mm | [mm] | resin portion P [%] | [MPa] |
| Example 1 | A | B | B | B | 0.24 | 5.7 | 490 |
| Example 2 | A | B | A | B | 0.16 | 3.8 | 610 |
| Example 3 | A | B | A | A | 0.13 | 2.5 | 660 |
| Comparative | C | C | C | C | — | — | 750 |
| Example 1 | | | | | | | |

### INDUSTRIAL APPLICABILITY

We provide a production method for a fiber reinforced plastic, in which a wrinkle-free preform can be formed by hot forming and the resulting fiber reinforced plastic exhibits high mechanical properties, and can also provide a fiber reinforced plastic having high mechanical properties in spite of its complicated shape and thus can be used for structural applications such as in aircraft, spacecraft, motor vehicles, railways, ships, electric appliances, sports and the like.

1.-8. (canceled)

9. A method of producing a fiber reinforced plastic, comprising:
a laminating step of laminating a plurality of groups of prepregs containing an incised prepreg to obtain a prepreg laminate, when the incised prepreg is formed by providing at least a partial region in a prepreg containing unidirectionally oriented reinforcing fibers and a resin with a plurality of incisions that divide the reinforcing fibers,
a forming step of disposing the prepreg laminate on a top surface of a mold containing the top surface and a side surface or disposing the prepreg laminate on a bottom surface of a mold containing the bottom surface and a side surface, and bending and forming the prepreg laminate along the side surface to obtain a preform having an approximate shape of the mold, and
a solidifying step of disposing and solidifying the preform in a mold different than the mold used in the forming step.

10. The method according to claim 9, wherein, when a population is made up of numbers of incisions contained in ten small circular regions of 10 mm in diameter arbitrarily selected in the region of the incised prepreg, the incised prepreg has a mean value for the population of 10 or greater and a coefficient of variation for the population within 20%.

11. The method according to claim 10, wherein absolute values of angles θ formed between the incisions and an orientation direction of the reinforcing fibers are substantially the same, the positive incisions whose θ is positive and the negative incisions whose θ is negative are approximately equal in number and, as an interval between a given incision and another incision that is present on an extended line of the incision and that is most proximate to the incision, intervals between the positive incisions and intervals between the negative incisions are different in length from each other.

12. The method according to claim 9, wherein the preform contains at least one out-of-plane deformation, and the height of the out-of-plane deformation is 0.5 times or more and 3 times or less the mean thickness of the prepreg laminate.

13. The method according to claim 9, wherein, in the forming step, at least a partial region of the preform having an approximate shape of the mold is pressed against the mold for planarization while applying a shear stress.

14. A fiber reinforced plastic comprising a resin and a reinforcing fiber and having a planar surface portion and a curved surface portion,
wherein reinforcing fibers which are divided in at least a partial region are unidirectionally oriented, and resin portions P are present between fiber bundles adjacent to each other in the orientation direction of the reinforcing fibers, and
a layer A having the resin portions P in a way that a line segment interconnecting the end portions of the resin portions P is disposed obliquely to the orientation direction of the reinforcing fibers is present closer to the external perimeter than to the internal perimeter of the curved surface portion of the fiber reinforced plastic.

15. The fiber reinforced plastic according to claim 14, wherein, in a given resin portion P in the plane of the layer A, the mean value of the distance of two parallel lines touching the outline of the resin portion P and having the shortest distance therebetween is 0.2 mm or less.

16. The fiber reinforced plastic according to claim 14, wherein the total volume of the resin portions P within the layer A is 5% or less of the volume of the layer A.

17. The fiber reinforced plastic according to claim 15, wherein the total volume of the resin portions P within the layer A is 5% or less of the volume of the layer A.

18. The method according to claim 10, wherein the preform contains at least one out-of-plane deformation, and the height of the out-of-plane deformation is 0.5 times or more and 3 times or less the mean thickness of the prepreg laminate.

19. The method according to claim 11, wherein the preform contains at least one out-of-plane deformation, and the height of the out-of-plane deformation is 0.5 times or more and 3 times or less the mean thickness of the prepreg laminate.

20. The method according to claim 10, wherein, in the forming step, at least a partial region of the preform having an approximate shape of the mold is pressed against the mold for planarization while applying a shear stress.

21. The method according to claim 11, wherein, in the forming step, at least a partial region of the preform having an approximate shape of the mold is pressed against the mold for planarization while applying a shear stress.

22. The method according to claim 12, wherein, in the forming step, at least a partial region of the preform having an approximate shape of the mold is pressed against the mold for planarization while applying a shear stress.
